(19) United States
(12) Patent Application Publication
(10) Pub. No.: US 2008/0218398 A1
(43) Pub. Date: Sep. 11, 2008

(54) Remote control integration device for controlling electronic devices

(76) Inventors: Po-Wen Jeng, Taichung City (TW); Po-Nien Chen, Taichung City (TW); Liang-Chia Tseng, Taichung City (TW); Yad-Jen Chang, Taichung City (TW); Chun-Ming Huang, Taichung City (TW)

Correspondence Address: Po-Wen Jeng, 235 Chung - Ho, Box 8-24, Taipei, TW

(21) Appl. No.: 11/715,485

(22) Filed: Mar. 8, 2007

(51) Int. Cl. H04L 17/02

(52) U.S. Cl. 341/176

(57) ABSTRACT

A remote control integration device for controlling electronic devices, comprises a remote controller having a memory unit for storing an instruction set having a plurality of instructions; a key set having a plurality of keys; a first transceiver and a first processor for generating instruction signals according to operation of keys; for storing the instruction set to the memory unit and for emitting the generating instruction signals and the instruction set in the memory unit through the first transceiver; and a remote controller having a second transceiver; and a second processor receiving the instructions or instruction set from the remote controller; and decoding the receiving signals into control signals; and a switch receiving electric power and outputting the electric power according to the decoding signals from the second processor.

### FIELD OF THE INVENTION

The present invention relates to remote controllers, and particularly to a remote control integration device for controlling electronic devices, which can control more electronic devices and set more completed control modes.

### BACKGROUND OF THE INVENTION

Currently many electronic devices are used at homes which are distributed in many different places. Thus remote controllers become necessary devices.

With referring to FIG. 1, a light adjusting remote controller is illustrated for adjusting the illuminations of two bulbs.

A wireless transmitter 1 has a plurality of keys 11, an encoder 12 and a transmitter 13. When the keys 11 are operated, the encoder 12 generates an identification code of the wireless transmitter 1 and RF signals corresponding to the operated key 11. Then the signals are transmitted through the transmitter 13.

A light adjusting circuit 2 has a receiver 21, a fin-adjusting controller 22, an optical coupling module 23, a phase control module 24 and a power supply 25. The optical coupling module 24 includes two phase adjusting micro controller 241 and two power drivers 242. Each optical coupler 231 is serially connected to one phase control micro controller 241 and one power driver 242 for controlling a bulb 3.

The power supply 25 receives an alternative current power which is then provided to the two power driver 242 and the two bulbs 3 and the AC current is converted into lower voltage DC current which is provided to the receiver 21, the micro controller 22 and the two phase controlled micro controller 241.

The micro controller 22 stores the identification code and decoding information of the RF signals from the wireless transmitter 1. The micro controller 22 receives the identification code and RF signals from the wireless transmitter 1. When the identification code is acknowledged, the received RF signals are decoded into control signals.

The two light coupler 231 transfers the decoding control signals decoded by the micro controller 22 to the two phase controlled micro controller 241 and isolates and protects the lower voltage micro controller 22 and high voltage phase control module 24.

The two phase control micro controllers 241 perform phase angle control about the conduction of the two power drivers 242 according to the received pulse widths of the control signals so that the two bulbs 3 change illumination based on the conduction phase angle of the two bulbs 3.

However since the wireless controller 1 has no memory function, it can not record the set mode. Each time, the bulb lights up, the wireless controller 1 must be renewed for adjusting the illumination of each bulb 3 to have a preferred state. When there are many bulbs 3, it is tedious to set the illuminations of the bulbs one by one.

Thus to avoid inconvenience in working, the number of bulbs controlled by the wireless controller 1 is limited.

### SUMMARY OF THE INVENTION

Accordingly, the primary object of the present invention is to provide a remote control integration device for controlling electronic devices, which can control more electronic devices and set more completed control modes.

To achieve above objects, the present invention provides a remote control integration device for controlling electronic devices, comprising a remote controller having a memory unit for storing an instruction set having a plurality of instructions; a key set having a plurality of keys; a first transceiver and a first processor for generating instruction signals according to operation of keys; for storing the instruction set to the memory unit and for emitting the generating instruction signals and the instruction set in the memory unit through the first transceiver; and a remote controller having a second transceiver; and a second processor receiving the instructions or instruction set from the remote controller; and decoding the receiving signals into control signals; and a switch receiving electric power and outputting the electric power according to the decoding signals from the second processor.

The various objects and advantages of the present invention will be more readily understood from the following detailed description when read in conjunction with the appended drawing.

### BRIEF DESCRIPTION OF THE DRAWINGS

FIG. 1 is a block diagram about the prior art light adjusted device.

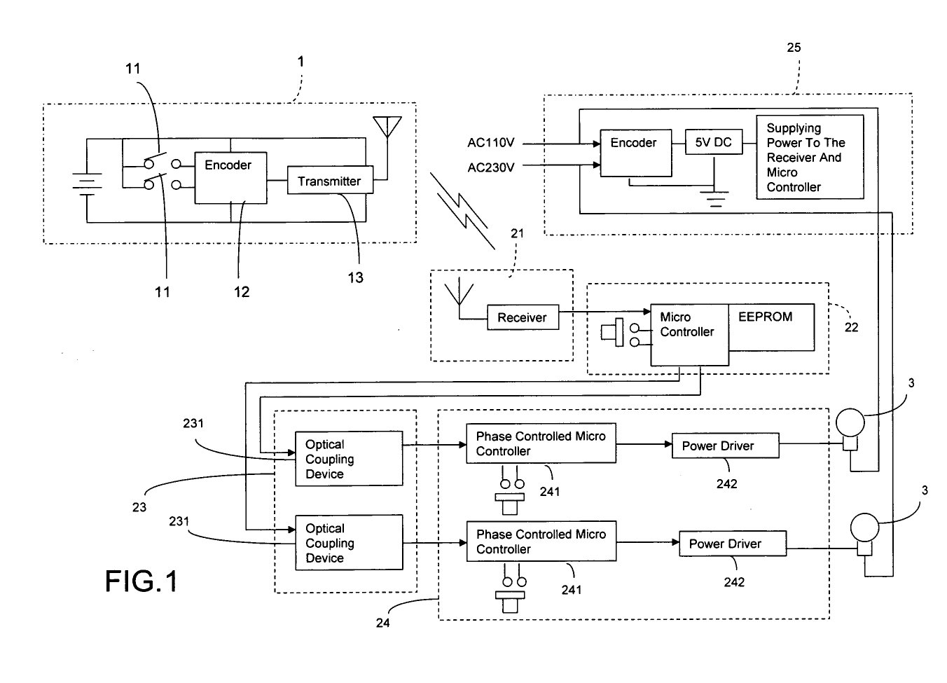

FIG. 2 is a block diagram about the first embodiment of the present invention.

FIG. 3 is a block diagram about the second embodiment of the present invention.

FIG. 4 is a circuit block diagram about the light adjusted signal generating unit of the second embodiment.

FIG. 5 is a block diagram about the control of the third embodiment.

FIG. 6 is a block diagram about the added receiving units in the third embodiment.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

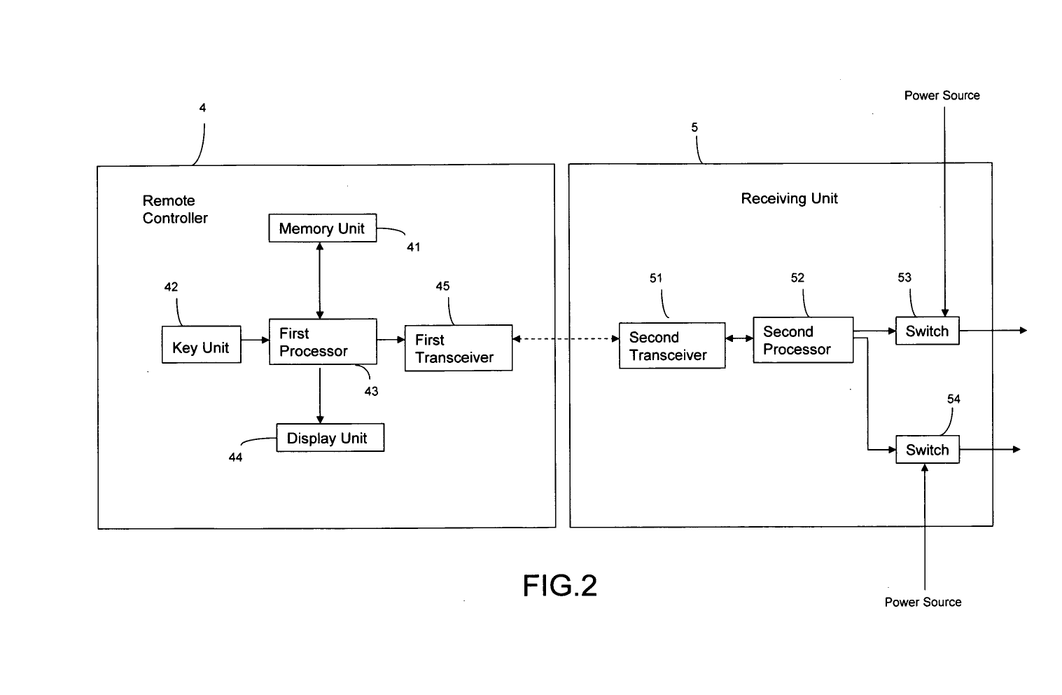

Referring to FIG. 2, the first preferred embodiment of the present invention is illustrated. In this embodiment, the present invention has the following elements.

A remote controller 4 includes a memory unit 41, a key set 42, a first processor 43, a display unit 44 and a first transceiver 45. The remote controller 4 is operated at one of a setting mode and an operation mode. The remote controller 4 has a locking function so as to prevent from some faults due to the fault operation from children.

In the setting mode, the hard ware number of each receiver 5 is inputted by clicking keys and a number code indicating the receiver 5 is given. Then in operation mode, the receiver 5 can be operated by the indication number of the receiver 5.

The memory unit 41 serves for storing an instruction set having a plurality of instructions. Each instruction set is corresponding to a set state.

The key set 42 includes a plurality of keys (not shown). When the keys are operated in setting mode, the first processor 43 generates display information and order signals in the operation mode. The display information is transferred to the display unit 44 for being displayed. The instruction set having a plurality of instructions is stored in the memory unit 41. When the keys are operated in operation mode, the first processor 43 generates display information according to operated keys and the display information is transferred to the display unit 44. An instruction set in the memory unit 41 or generated signals are transferred wirelessly through the first transceiver 45.

It should be noted that the display unit 44 may be a liquid crystal display or a light emitting diode display, but it is not confined to these devices. Furthermore, when the remote controller 4 is powered off or is operated in power saving mode, the state of the receiver 5 is not changed.

The receiver 5 includes a second transceiver 51, a second processor 52 and at least one switch. In this embodiment, the receiver 5 has a switch 53 and a switch 54 as an example.

The second processor 52 receives the instruction signals from the remote controller 4 through the second transceiver 51 and decodes the received signals as control signals.

Each of switch 53, 54 transmits power to a electronic devices according to control signals decoded by the second processor 52.

Preferably, after receiving the instructions, the second processor 52 of the receiver 5 checks whether the signals are correct. If yes, the received signals are decoded into control signals and the second transceiver 51 transmits out an acknowledge signal. Otherwise, a non-acknowledge signal is sent out.

When the acknowledge signal or non-acknowledge signal from the receiver 5 is received by the first processor 43 of the remote controller 4, a program is used to determine whether it is necessary to resent instructions to the second transceiver 51. Thus, fault operations can be avoid even the signals decays or are interfered.

In this embodiment, each of the instructions, acknowledge signals, non-acknowledge signals includes an initial section for indication the initial position of the signal, a source section for indicating the indication code of the device transmitted the signals, an object section for indicating the indication code of the device received the signal, a message section including the operation and transferring data of a selected device and an ending section for indicating the ending of the signal.

In the instruction signals, the source section records the identification codes of the remote controller 4. The object section records the identification code of the receiving device. The signal message section records the selected switch in the receiver 5. Thus, the remote controller 4 can control the switch 53 and switch 54 of the receiver 5 to be fully conducted, fully turn off and only one being conducted.

In the acknowledge signal and the non-acknowledge signal, the source section records the identification code of the receiver 5 and the object section records the identification code of the remote controller 4. The message section records that the receiving is acknowledged or a non-acknowledged. It should be noted that the message section can record other message. For example the state of the electronic devices connected to the switch 53 and switch 54.

In this embodiment, the communication between the first transceiver 45 of the remote controller 4 and the second transceiver 51 of the remote controller 4 is based on the IEEE 802.15.4, but this is not confined in the present invention.

In this the present invention, when the key set 42 of the remote controller 4 is operated, the display unit 44 displays the code and action of the selected switch of the receiver 5.

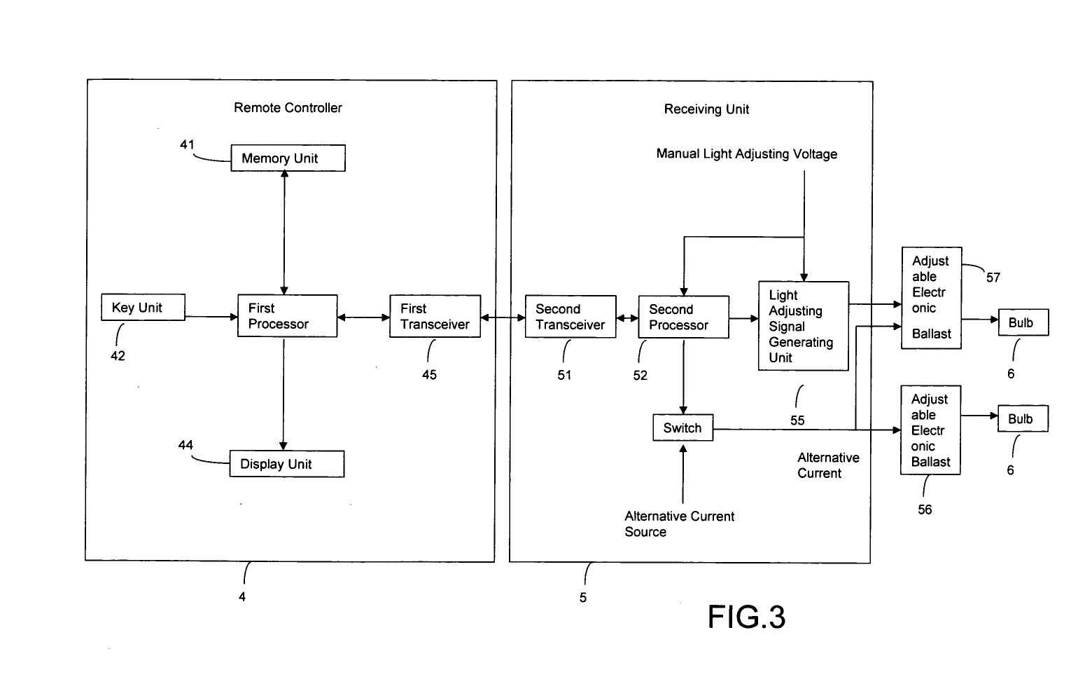

Referring to FIG. 3, the second embodiment of the present invention is illustrated. An integrated system for remotely controlling electronic devices according to the present invention is illustrated, which is used to control at least one electronic ballast. Each electronic ballast is electrically connected to a bulb 6 and can change the illumination of the bulb 6. When the second embodiment is used to control a plurality of electronic ballast. The power sources of these electronic ballast are connected together. In this embodiment, there are two electronic ballast 56, 57, which are used as an example. In this embodiment, those identical to the above embodiment will not be further described herein. Only those different from above embodiment are described.

The receiver 5 includes a second transceiver 51, a second processor 52, a switch 53 and a light adjusting unit 55.

The second processor 52 receives instructions or instruction set from the second transceiver 51 and then decodes the receiving signals into control signals.

The switch 53 receives an alternative current signals and decides to output the current to an electronic ballast according to the decoded signals.

The light adjusting signal generating unit 55 receives a manual light adjusted voltage and generates another light adjusting voltage according to the control signals (such as b1, b2, b3, . . . ). One of the two light adjusting voltages is outputted to the two electronic ballast 56, 57.

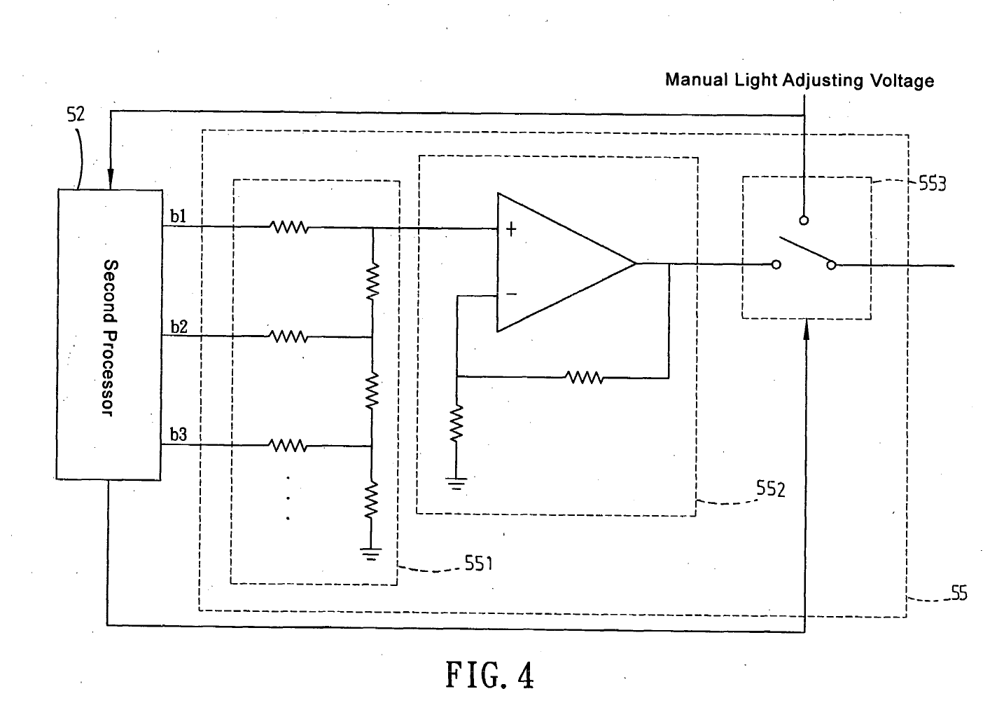

Referring to FIG. 4, in this embodiment, a light adjusted signal generating unit 55 includes a digital to analog converter 551, an amplifier 552 and an switch unit 553 (only the second processor 52 and the light adjusting unit 55 are illustrated). The digital to analog converter 551 generates an analog signal according to the control signals from the second processor 52. The second processor 52 detects the manual light adjusted voltage. If the light adjusted voltage is detected, the switch unit 553 will output the manual light adjusted voltage, otherwise, the switch unit 553 outputs the remotely control light adjusted voltage. The light adjusted signal generating unit 55 outputs voltages within a range of 0 to 12 volts.

It should be noted that the receiver 5 can be controlled by the remote controller 4 or the manual light adjusted voltage so as to control the light adjusted voltage.

In the instructions, the source section records the identification code of the remote controller 4. The object section records the identification code of the receiver 5. The message section records the states of the switch 53 and the light adjusted signal generating unit 55, and the states of conduction and non-conduction and the corresponding values of the light adjusted voltage. Therefore, the remote controller 4 can control the two bulbs 6 to light up, distinguished and the illumination of the bulbs 6.

In the signals of acknowledge signal and non-acknowledge signal, the source section records the identification code of the receiver 5 and the object section records the identification code of the remote controller 4. The message section records the state of acknowledgement and non-acknowledgement. It should be noted that the message section can records other message, for example the illuminations of the two bulbs 6.

In this embodiment, when the key set 42 of the remote controller 4 is controlled, the display unit 44 will display the state of the switch 53 of the receiver 5 or the state of the switch 53 of the receiver 5.

It should be noted that in the first and second embodiments, the remote controller 4 can be used with a plurality of receivers 5.

In summary, since the memory unit 41 of the remote controller 4 stores one instruction set having a plurality of instructions for control the keys of the key set 42 so as to transfer the select instructions wirelessly through the first transceiver 45 for controlling electronic devices 711, 712, and 713. For example when the user comes home, he (or she) can click a key for lighting up a lamp and to adjust the illumination of the lamp, actuating an air conditioner, playing music from stereo, or closing a curtain. Thus, the present invention can control a plurality of electronic devices and setting complicated operation modes conveniently.

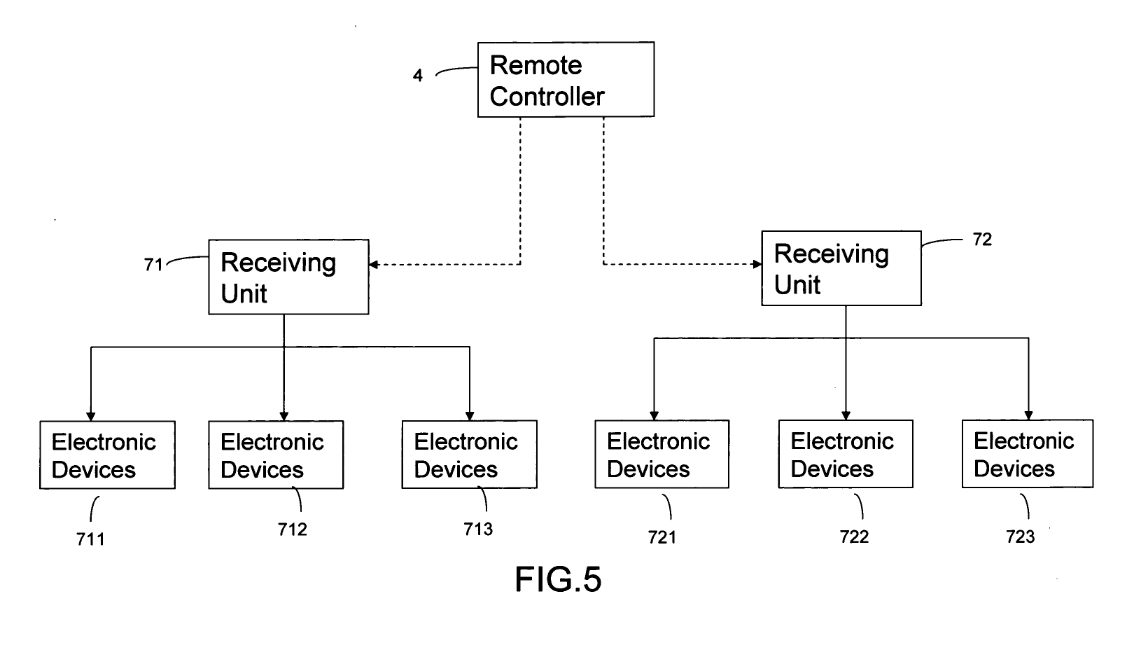

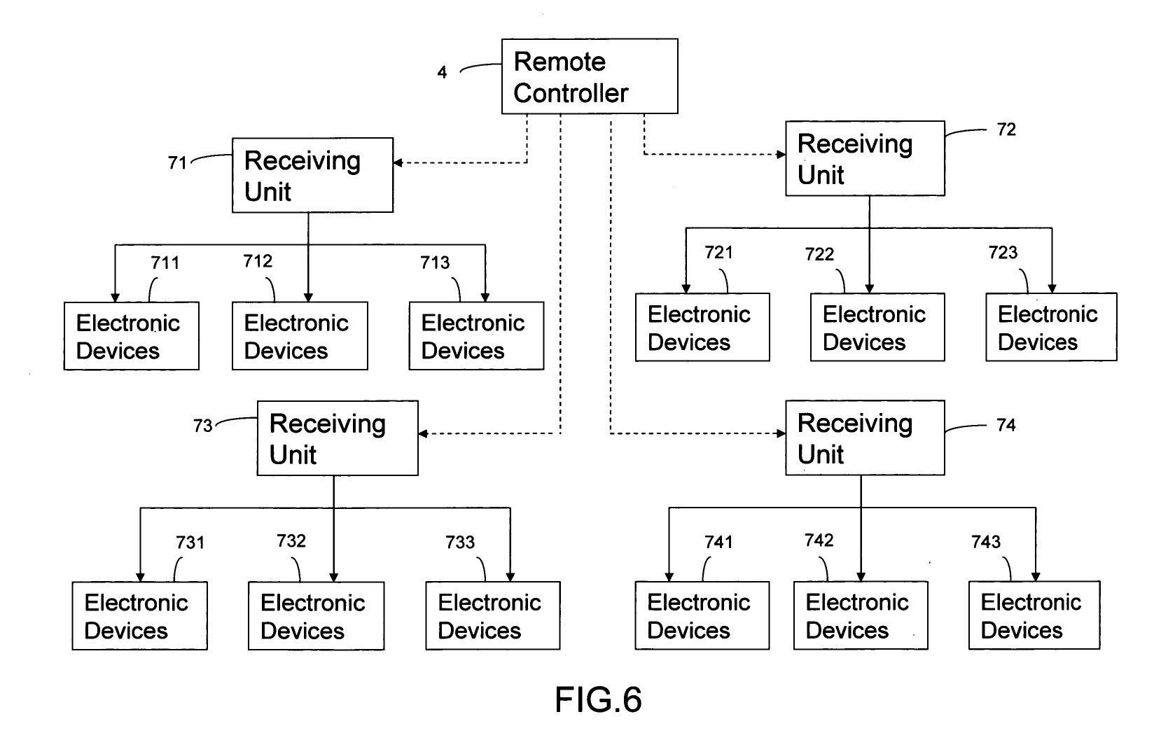

Referring to FIGS. 5 and 6, the third embodiment of the present invention is illustrated. In this embodiment, those identical to the above embodiment will not be further described herein. Only those different from above embodiment are described.

In FIG. 5, the remote controller 4 is connected to the receiving units 71, 72. The receiving units 71, 72 receive the instructions from the remote controller 4 for controlling the electronic devices 711, 712, and 713 and electronic devices 721, 722, and 723 (in this embodiment, two receiving units and two sets of electronic devices are used as examples, but these are not used to confine the scope of the present invention).

When the user needs to add the control for other extra electronic devices to the remote controller 4, referring to FIG. 6, the user can add a new receiving unit 73 to be connected to the added electronic devices 731, 732, and 733. Then the remote controller 4 records the dedicate hardware number of the receiving unit 73 and then an unused number is assigned to the receiving unit 73 for controlling the electronic devices 731, 732, and 733.

If the user needs to the add the control to other electronic devices, a further receiving unit 74 can be added. Similarly, the user can add a new receiving unit 74 to be connected to the added electronic devices 741, 742, and 743. Then the remote controller 4 records the dedicate hardware number of the receiving unit 74 and then an unused number is assigned to the receiving unit 74 for controlling the electronic devices 741, 742, and 743.

In the present invention, the receiving unit can be added for controlling various electronic devices. The number of the added receiving units is not confined by two. Thereby if one receiving unit is not used, the number of that receiving unit 7 can be cancelled.

Moreover, the electronic devices controlled through the instruction set in the remote controller 4 can be connected to various receiving units. With referring to FIG. 6, the receiving unit 71 serves to control the electronic devices 711, the receiving unit 72 serves to control the electronic devices 723, the receiving unit 73 serves to control the electronic devices 731, and 732 and the receiving unit 74 serves to control the electronic devices 742. These receiving units can be set with one instruction set for controlling all electronic devices 711, 723, 731, 732, and 742 through the receiving units 71, 72, 73 and 74. Thus the operation can be performed easily by the user.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A remote control integration device for controlling electronic devices, comprise:
a remote controller having
a memory unit for storing an instruction set having a plurality of instructions;
a key set having a plurality of keys;
a first transceiver and
a first processor for generating instruction signals according to operation of keys; for storing the instruction set to the memory unit and for emitting the generating instruction signals and the instruction set in the memory unit through the first transceiver; and
a remote controller having
a second transceiver; and
a second processor receiving the instructions or instruction set from the remote controller; and decoding the receiving signals into control signals; and
a switch receiving electric power and outputting the electric power according to the decoding signals from the second processor.

2. The remote control integration device as claimed in claim 1, wherein the remote controller includes a display unit and the first processor generates display information which is then transferred to the display unit.

3. The remote control integration device as claimed in claim 2, wherein the second processor checks whether the receiving signal is correct and then decodes the received signals into control signals; if correct, an acknowledge signal is emitted through the second transceiver; otherwise, a non-acknowledge signal is emitted through the second transceiver; the first processor of the remote controller receives the acknowledge signal or non-acknowledge signal through the first transceiver; and then transfers the received signals to the display unit.

4. The remote control integration device as claimed in claim 2, wherein the display unit of the remote controller is a liquid crystal display.

5. The remote control integration device as claimed in claim 2, wherein the display unit of the remote controller is a light emitting diode display.

6. The remote control integration device as claimed in claim 1, wherein the communication between the first transceiver of the remote controller and the second transceiver of the remote controller is based on IEEE 802.15.4.

7. The remote control integration device as claimed in claim 1, wherein the receiving unit includes a light adjusting signal generating unit; the light adjusting signal generating unit receives a manual light adjusted voltage and generates another light adjusting voltage according to the control signals decoded from the second processor; one of the two light adjusting voltages are outputted.

8. The remote control integration device as claimed in claim 7, wherein the light adjusted signal generating unit includes a digital to analog converter, an amplifier and an switch unit; the digital to analog converter generates an analog signal according to the control signals from the second processor; the second processor detects the manual light adjusted voltage; if the light adjusted voltage is detected, the switch unit will output the manual light adjusted voltage, otherwise, the switch unit outputs the remotely control light adjusted voltage.

9. The remote control integration device as claimed in claim 7, wherein the light adjusted signal generating unit outputs voltages within a range of 0 to 12 volts.

10. The remote control integration device as claimed in claim 1, wherein the remote controller records a hardware number of the receiving unit and assigns a number for controlling the receiving unit.

11. The remote control integration device as claimed in claim 1, wherein the receiving unit serves to control at least two receiving units which are connected to a plurality of electronic devices.

12. The remote control integration device as claimed in claim 1, wherein the remote controller sets one instruction set for electronic devices which are connected to different receiving units.

13. A remote controller comprising:
a memory unit for storing an instruction having at least one instructions;
a key set having a plurality of keys;
a transceiver; and
a processor for generating instructions according to the operation of keys;
and storing the instruction set into the memory unit; and for emitting the generating instructions or the instruction set in the memory unit wirelessly through the transceiver.

14. The remote controller as claimed in claim 13, wherein the process generates display information and transfers the display information to a display unit.

15. The remote controller as claimed in claim 14, wherein the processor receives acknowledge signals and non-acknowledge signals through the transceiver; and the receives acknowledge signal and non-acknowledge signals are transferred to the display unit.

16. The remote controller as claimed in claim 14, wherein the display unit is a liquid crystal display.

17. The remote controller as claimed in claim 14, wherein the display unit is a light emitting diode display.

18. The remote control integration device as claimed in claim 13, wherein the transceiver transfers signals wirelessly based on IEEE 802.15.4.
